(19) United States
(12) Patent Application Publication
(10) Pub. No.: US 2019/0230103 A1
(43) Pub. Date: Jul. 25, 2019

(54) Method To Detect A Summoning Attack By A Rogue WiFi Access Point

(71) Applicant: QUALCOMM Incorporated, San Diego, CA (US)

(72) Inventors: Kevin Hart, La Mesa, CA (US); Sriram Nandha Premnath, San Diego, CA (US); Shyama Prasad Mondal, San Diego, CA (US); Dineel Sule, San Diego, CA (US); Pankaj Garg, San Diego, CA (US)

(21) Appl. No.: 15/878,074

(22) Filed: Jan. 23, 2018

(51) Int. Cl. H04L 29/06; H04W 12/12

(52) U.S. Cl. CPC H04L 63/1425; H04L 63/1466; H04W 12/12

(57) ABSTRACT

Various methods for detecting a summoning attack by a malicious access point (AP) may include generating a random service set identifier (SSID), transmitting a probe request including the random SSID, determining whether a probe response including the random SSID is received, identifying an AP as a rogue AP in response to receiving a probe response including the random SSID, and in response to not receiving a probe response including the random SSID: generating a second SSID comprising a random selection of a plurality of words; transmitting a second probe request including the second SSID; determining whether a probe response including the second SSID is received; identifying an AP as a rogue AP in response to determining that a probe response including the second SSID is received; and determining that no rogue AP is present in response to determining that a probe response including the second SSID is not received.

### BACKGROUND

Using WiFi to establish a network connection has become very common. To connect to a network via WiFi, a WiFi client on a computing device or computer will broadcast a directed probe request that includes a specific service set identifier (SSID). Because the directed probe request is sent as a broadcast, any WiFi access point (AP) in the area will receive the probe request and can determine the included SSID. A malicious or rogue AP may impersonate a “real” AP by responding with a probe response that includes the same SSID. A WiFi client may respond to impersonating probe response by connecting to the malicious or rogue AP. This is often referred to as a “summoning attack” that enables the rogue AP to monitor network traffic, introduce malware and perform other malicious activities in a form of “man-in-the-middle” attack.

### SUMMARY

Various embodiments include methods for operating a computing device. Various embodiments may include generating a random service set identifier (SSID), transmitting a WiFi probe request including the random SSID, determining whether a probe response including the random SSID is received, identifying a WiFi access point (AP) as a rogue AP in response to receiving a probe response including the random SSID and, in response to determining that no probe response including the random SSID is received, generating a second SSID including a random selection of a plurality of words, the second SSID being different from an existing SSID associated with an authorized WiFi AP, transmitting a second probe request including the second SSID, determining whether a probe response including the second SSID is received, identifying a WiFi AP as a rogue AP in response to determining that a probe response including the second SSID is received, and determining that no malicious WiFi AP is present in response to determining that a probe response including either of the first or second SSIDs is not received.

In some embodiments, generating a second SSID including a random selection of a plurality of words may include randomly selecting each of the plurality of words from a database of words and concatenating the plurality of words into a single string, in which the single string is less than or equal to 32 bytes. In such embodiments, concatenating the plurality of words into a single string may involve including a non-alphabetic character as a separator between each of the plurality of words. In such embodiments, the non-alphabetic character maybe the same for each separator. In such embodiments, concatenating the plurality of words into a single string may involve including one or more non-alphabetic characters as a separator between each of the plurality of words. In such embodiments, concatenating the plurality of words into a single string may involve including an underscore character as a separator between each of the plurality of words. In such embodiments, each of the plurality of words in the database of words may be a three-letter word, a total number of the plurality of words maybe less than or equal to eight, and a non-alphabetic character maybe included as a separator between each of the plurality of words. In such embodiments, each of the plurality of words has the same number of letters and a total number of the plurality of words is such that a length of the second SSID is less than or equal to 32 bytes. In some embodiments, one or more of the plurality of words has a different number of letters and a total number of the plurality of words is such that a length of the second SSID is less than or equal to 32 bytes.

Some embodiments may include repeatedly transmitting the second probe request including the second SSID a predetermined number of times with a random interval between each transmission and repeatedly determining whether a probe response including the second SSID is received.

Various embodiments may include a computing device including a memory, a transceiver, and a processor configured with processor-executable instructions to perform operations of the methods summarized above. Further embodiments may include a non-transitory processor-readable storage medium having stored thereon processor-executable software instructions configured to cause a processor of a computing device to perform operations of the methods summarized above. Further embodiments may include a computing device that includes means for performing functions of the methods summarized above.

### BRIEF DESCRIPTION OF THE DRAWINGS

The accompanying drawings, which are incorporated herein and constitute part of this specification, illustrate exemplary embodiments of the claims, and together with the general description and the detailed description given herein, serve to explain the features of the claims.

FIG. 1 is a block diagram illustrating a system configured for detecting a summoning attack by a rogue access point (AP) in accordance with various embodiments.

FIGS. 2A and 2B are process flow diagrams illustrating methods for detecting a summoning attack by a rogue AP according to various embodiments.

FIG. 3 is a diagram illustrating a method for randomly generating a service set identifier (SSID) according to various embodiments.

FIG. 4 is a diagram illustrating a method for detecting a summoning attack by a rogue AP according to various embodiments.

FIG. 5 is a component diagram of an example computing device suitable for use with various embodiments.

FIG. 6 is a component diagram of an example server suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments include methods for detecting a summoning attack by a malicious access point (AP) which may include generating a random service set identifier (SSID) and transmitting a probe request that includes the random SSID (i.e., an SSID formed from a series of random characters, such as “alkhgh;2ieos”). Because the random SSID is generated randomly and not associated with an authorized AP, any probe response that includes the random SSID would only be generated by a malicious or rogue AP. Hence, if a computing device receives a probe response that includes the random SSID from an AP, the computing device may identify that AP as a malicious or rogue AP.

However, a rogue AP may be able to determine that the random SSID is not associated with an authorized AP. For example, the rogue AP may be able to evaluate the random SSID and determine that the random SSID is artificially formed from a series of random characters. If the rogue AP determines that the random SSID is not associated with an authorized AP, the rogue AP is unlikely to send a probe response that includes the random SSID. Because of this, if a computing device does not receive a probe response that includes the random SSID, the computing device cannot determine that there are no rogue APs in an area.

Various embodiments may include taking additional actions if a computing device does not receive a probe response that includes the random SSID. For example, various embodiments may further include generating a second SSID that includes a plurality of random words and transmitting a second probe request that includes the second SSID. In various embodiments, the second SSID may be formed with a plurality of three-letter words (e.g., “hat_old_cat”). In other embodiments, each word may include more or fewer letters. Because the second SSID is formed with otherwise “real” words, a rogue AP is less likely to determine that the second SSID is not associated with an authorized AP. When a rogue AP receives the second probe request that includes the second SSID and is unable to determine that the second SSID is not associated with an authorized AP, the rogue AP will send a probe response that includes the second SSID. If a computing device receives a probe response that includes the second SSID from an AP, the computing device may identify that AP as a rogue AP.

As used herein, the term “computing device” refers to any of a variety of communication and computing devices having a processor and Wi-Fi communication circuitry, including for example mobile communication devices (e.g., cellular telephones, wearable devices, smart-phones, web-pads, tablet computers, Internet enabled cellular telephones, Wi-Fi® enabled electronic devices, personal data assistants (PDA's), etc.), and personal computers. Non-limiting examples of personal computers one or more of a desktop computer, a laptop computer, a handheld computer, a tablet computing platform, a NetBook, a Smartphone, a gaming console, and/or other computing platforms. A computing device may include a plurality of hardware, software, and/or firmware components operating together to provide the functionality attributed herein to the computing device.

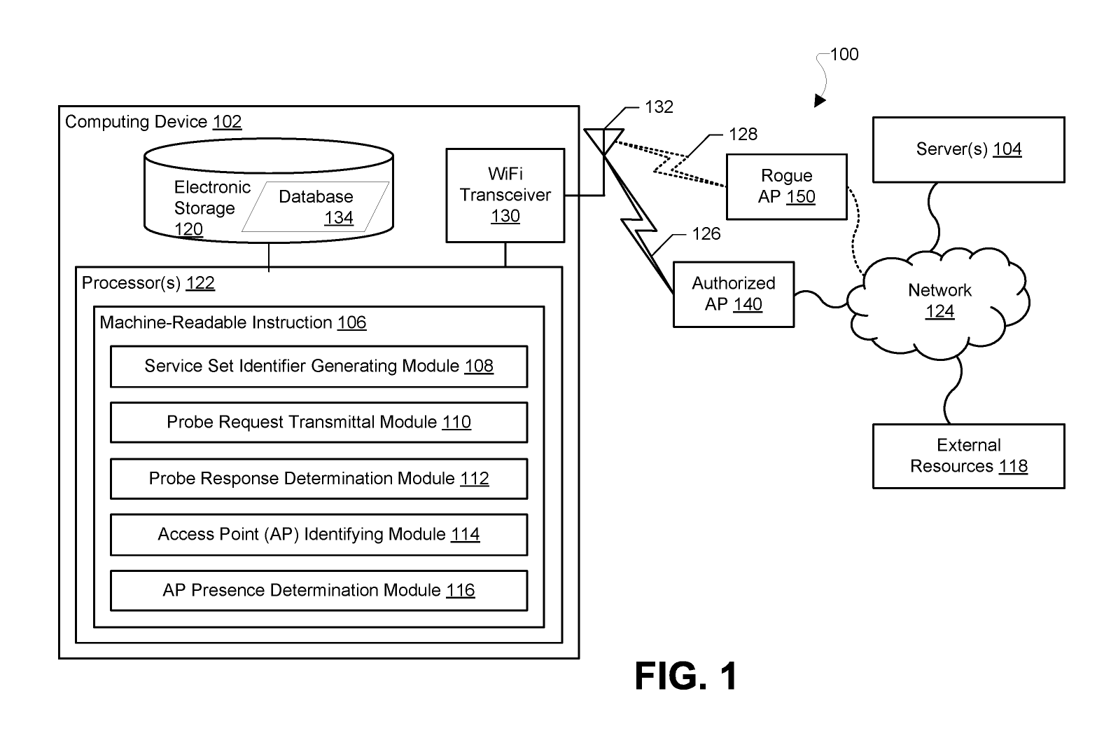

FIG. 1 illustrates a system 100 configured for detecting a summoning attack by a malicious WiFi access point (AP) in accordance with various embodiments. In some embodiments, the system 100 may include a computing device 102 and one or more authorized Wi-Fi APs 120 coupled to a network 124, such as the Internet. The computing device 102 may be configured to communicate with one or more server(s) 104 and other external resources 118 via the network 124 by establishing a Wi-Fi communication link 126 with an authorized AP 140 configured to relay communications between the network 124 and the computing device 102

In some instances, a rogue AP 150 may also be present within the WiFi communication range of the computing device 102. In such circumstances, the computing device 102 may receive Wi-Fi signals 128 from the rogue AP 150 in response to a probe communication including an SSID. The rogue AP 150 may relay communications to the network 124 on behalf of the computing device 102, such as in executing a man in the middle attack. On the other hand, a rogue AP 150 may not provide or fake communications with the network 124, and instead attempt to load malware or obtain personal data from the computing device 102 via an established Wi-Fi communication link 128. Thus, there is a need for computing devices to be able to detect rogue APs so that the computing devices may avoid establishing a Wi-Fi link 128 that could lead to a malware or man in the middle attack.

The computing device 102 may include one or more processor(s) 122 that may be coupled to electronic storage 120. The electronic storage 120 may include a database 134. The computing device 102 may include a Wi-Fi transceiver 130 coupled to the one or more processors 122 and configured to exchange Wi-Fi wireless signals via an antenna 132.

The computing device 102 may be configured by machine-readable instructions 106, which when executed by processor(s) 122 may enable the computing device 102 to perform operations of various embodiments. Machine-readable instructions 106 may include one or more instruction modules or computer program modules. The instruction modules may include one or more of a service set identifier generating module 108, a probe request transmittal module 110, a probe response determination module 112, an access point identifying module 114, an AP presence determination module 116, and/or other instruction modules.

A service set identifier generating module 108 may include instructions configured to cause the processor 122 to generate a random service set identifier (SSID). The random SSID may be formed by a series of random alphanumeric characters (e.g., “aslj-p2jlioos”) as described herein. In various embodiments, the random SSID may be compared to a list of SSIDs corresponding to authorized APs within an area to ensure the random SSID does not match an existing authorized SSID.

The service set identifier generating module 108 may include instructions configured to cause the processor 122 to generate a second SSID that includes a random selection of a plurality of words. Generating a second SSID that includes a random selection of a plurality of words may include randomly selecting each of the plurality of words from a collection of words and concatenating the plurality of words into a single string. For example, a random number R of words may be selected from a database of N words, such as from the database 134. Concatenating the plurality of words into a single string may involve including a non-alphabetic character as a separator between each of the plurality of words. For example, an underscore (“_”) or a dash (“-”) may be used as a separator between each of the plurality of words. The non-alphabetic character may be the same for each separator such as the “_” in “hat_cat_old”. Alternatively, each separator may be a different non-alphabetic character, such as in “hat_cat-old_tie” or “hat!cat_old-tie”. Concatenating the plurality of words into a single string may involve including one or more non-alphabetic characters as a separator between each of the plurality of words, such as in “hat_!cat—old$tie”.

In some embodiments, each of the plurality of words may contain the same number of letters. For example, each of the plurality of words may be a three-letter word. The plurality of words may contain a differing number of letters. Of note, an SSID may be no longer than 32 bytes. For example, if each of the plurality of words is a three-letter word and a single non-alphabetic character is included as a separator, the total number of words would be eight (8).

In various embodiments, the second SSID may be selected so that it is different from any existing (i.e. valid) SSID associated with an authorized AP, such as authorized AP 140. That is, the second SSID should not be an SSID already in use by an authorized AP within Wi-Fi communication range of the computing device 102. To ensure this, in some embodiments the second SSID (as well as the first SSID) may be checked against a list of real authorized AP SSIDs to confirm that the second SSID does not match any real authorized AP SSID.

A probe request transmittal module 110 may include instructions configured to cause the processor 122 to transmit a probe request that includes the random SSID. The probe request transmittal module 110 may also include instructions configured to cause the processor 122 to transmit a second probe request including the second SSID. In some embodiments, the probe request transmittal module 110 may include instructions configured to cause the processor 122 to repeatedly transmit the second probe request including the second SSID a predetermined number of times with a random interval between each transmission.

A probe response determination module 112 may include instructions configured to cause the processor 122 to determine whether a probe response that includes the random SSID is received by the computing device 102. For example, if an AP, such as rogue AP 150, responds to the probe request that includes the random SSID with a probe response that includes the random SSID, the probe response determination module 112 would determine that the computing device 102 has received that probe response.

A probe response determination module 112 may also include instructions configured to cause the processor 122 to determine whether a probe response including the second SSID is received by the computing device 102. For example, if an AP, such as rogue AP 150, responds to the probe request that includes the second SSID with a probe response that includes the second SSID, the probe response determination module 112 would determine that the computing device 102 has received that probe response. The probe response determination module 112 may include instructions configured to cause the processor 122 to repeatedly determine whether a probe response including the second SSID is received.

An access point identifying module 114 may include instructions configured to cause the processor 122 to identify an AP as a rogue AP in response to determining that a probe response that includes the random SSID is received. The access point identifying module 114 may also include instructions configured to cause the processor 122 to identify an AP as a rogue AP in response to determining that a probe response including the second SSID is received. For example, if a rogue AP 150 responds with either a probe response including the random SSID or a probe response including the second SSID, the access point identifying module 114 would recognize the response is coming from and an authorized (i.e. rogue), such as the rogue AP 150.

An AP presence determination module 116 may include instructions configured to cause the processor 122 to determine that no rogue AP is present in response to determining that a probe response including the second SSID is not received from an AP by the computing device 102.

The electronic storage 120 may include any form of non-transitory storage media that electronically stores information. The electronic storage media of electronic storage 120 may include one or both of system storage that is provided integrally (i.e., substantially non-removable) with the computing device 102 and/or removable storage that is removably connectable to the computing device 102 via, for example, a port (e.g., a Universal Serial Bus (USB) port, a Firewire port, etc.) or a drive (e.g., a disk drive, etc.). Electronic storage 120 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 120 may include one or more virtual storage resources (e.g., cloud storage, a virtual private network, and/or other virtual storage resources). The electronic storage 120 may store software algorithms, information determined by processor(s) 122, information received from server(s) 104, information received from the computing device 102, and/or other information that enables the computing device 102 to function as described herein.

The processor(s) 122 may be configured to provide information processing capabilities in the computing device 102. As such, the processor(s) 122 may include one or more of a digital processor, an analog processor, a digital circuit designed to process information, an analog circuit designed to process information, a state machine, and/or other mechanisms for electronically processing information. Although the processor(s) 122 is shown in FIG. 1 as a single entity, this is for illustrative purposes only. In some embodiments, the processor(s) 122 may include a plurality of processing units. Such processing units may be physically located within the same device, or the processor(s) 122 may represent processing functionality of a plurality of devices operating in coordination. The processor(s) 122 may be configured to execute instruction modules 108, 110, 112, 114, 116, and/or other modules by software; hardware; firmware; some combination of software, hardware, and/or firmware; and/or other mechanisms for configuring processing capabilities on processor(s) 122. As used herein, the term “module” may refer to any component or set of components that perform the functionality attributed to the module. This may include one or more physical processors during execution of processor readable instructions, the processor readable instructions, circuitry, hardware, storage media, or any other components.

Although the modules 108, 110, 112, 114, and 116 are illustrated in FIG. 1 as being implemented within a single processing unit, in implementations in which the processor(s) 122 includes multiple processing units, one or more of the modules 108, 110, 112, 114, and/or 116 may be implemented remotely from the other modules. The description of the functionality provided by the different modules 108, 110, 112, 114, and/or 116 described below is for illustrative purposes, and is not intended to be limiting, as any of the modules 108, 110, 112, 114, and/or 116 may provide more or less functionality than is described. For example, one or more of the modules 108, 110, 112, 114, and/or 116 may be eliminated, and some or all of its functionality may be provided by other ones of the modules 108, 110, 112, 114, and/or 116. As another example, the processor(s) 122 may be configured to execute one or more additional modules that may perform some or all of the functionality attributed below to one of modules 108, 110, 112, 114, and/or 116.

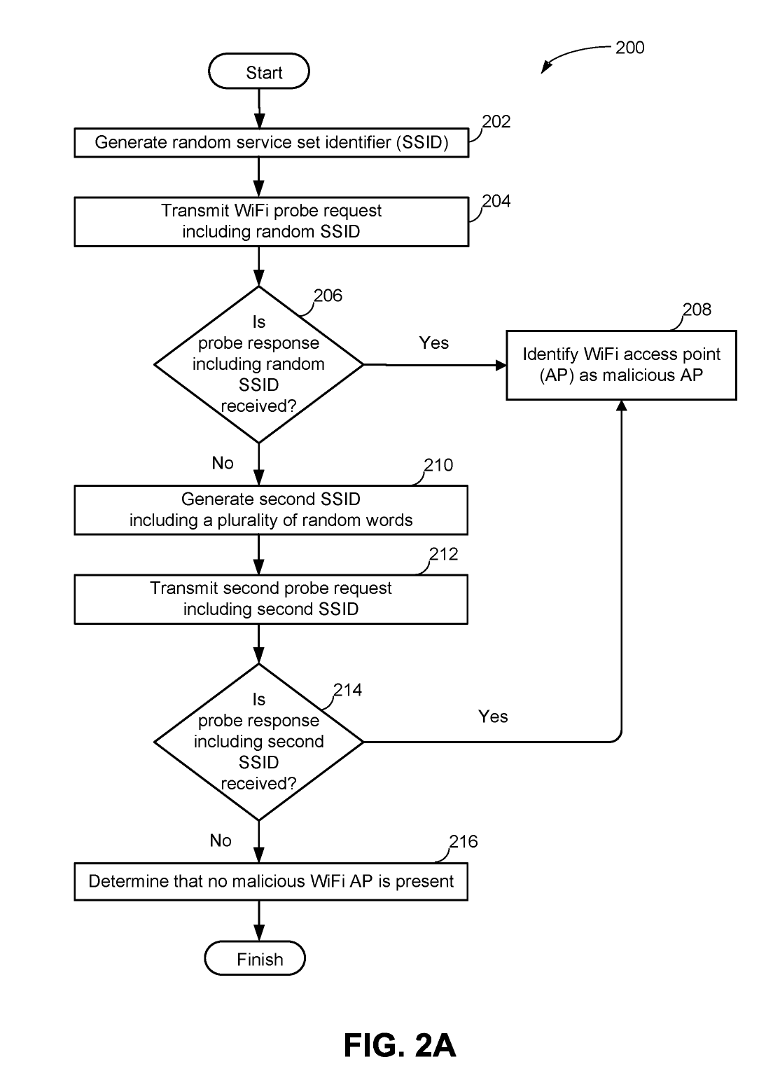

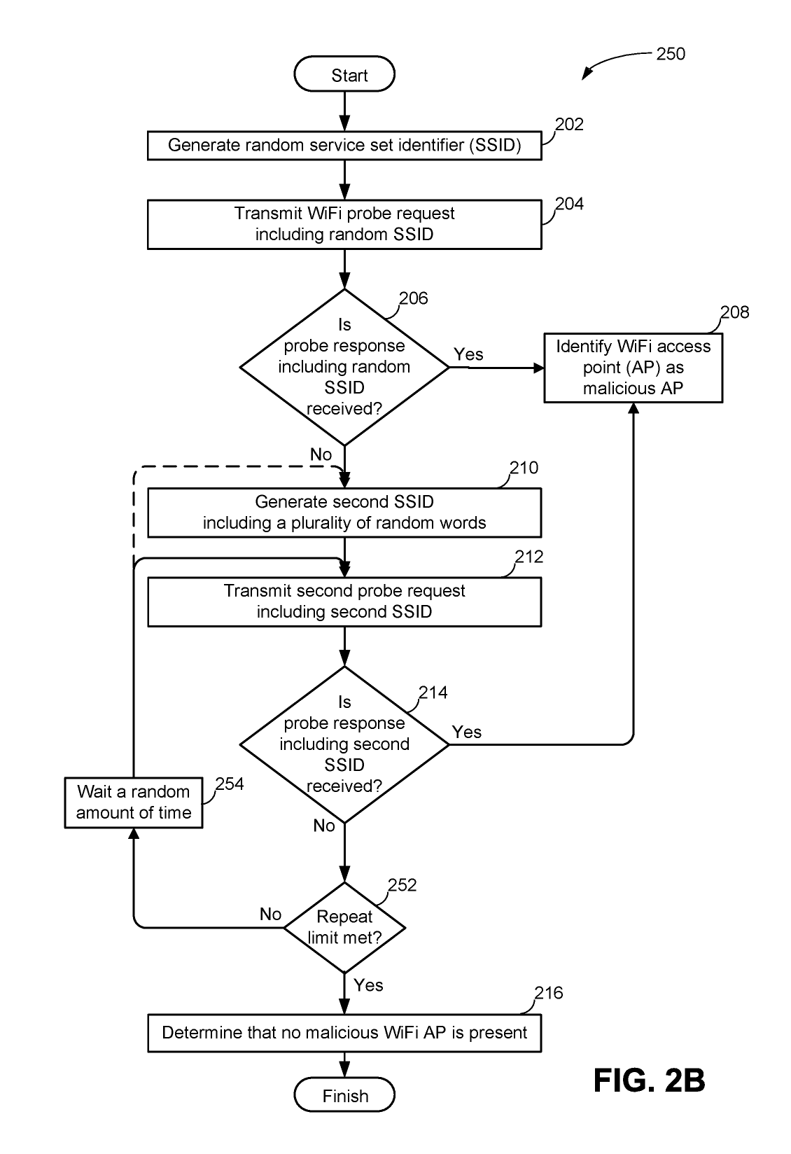

FIG. 2A illustrates a method 200 for detecting a summoning attack by a rogue AP, in accordance with various embodiments. The operations of the method 200 are intended to be illustrative. In some embodiments, method 200 may be accomplished with one or more additional operations not described, and/or without one or more of the operations discussed. Additionally, the order in which the operations of the method 200 are illustrated in FIG. 2A and described below is not intended to be limiting.

In some embodiments, the method 200 may be implemented in one or more processing devices (e.g., a digital processor, an analog processor, a digital circuit designed to process information, an analog circuit designed to process information, a state machine, and/or other mechanisms for electronically processing information), such as the processor 122 illustrated in FIG. 1. The one or more processing devices may include one or more devices executing some or all of the operations of the method 200 in response to instructions stored electronically on an electronic storage medium, such as the electronic storage 120. The one or more processing devices may include one or more devices configured through hardware, firmware, and/or software to be specifically designed for execution of one or more of the operations of the method 200.

In block 202, a processor of the computing device may generate a random SSID. For example, the processor(s) 122 of the computing device 102 may utilize service set identifier generating module 108 to generate a random SSID. The random SSID may be generating by the processor using any alphanumeric character. The random SSID may be less than or equal to 32 bytes.

In block 204, the processor may cause the Wi-Fi transceiver to transmit a probe request including the random SSID. For example, the processor(s) 122 of the computing device 102 may utilize a probe request transmittal module 110 to format the probe request that includes the random SSID, and direct that message to the Wi-Fi transceiver 130 for transmission.

In determination block 206, the processor may determine whether a probe response including the random SSID is received.

In response to receiving a probe response including the random SSID (i.e., determination block 206=“Yes”), the processor may identify the AP that sent the probe response as a rogue AP in block 208. In doing so, the processor may also take actions to protect against an attack such as discontinuing communications with that AP, displaying an alarm to a user, etc.

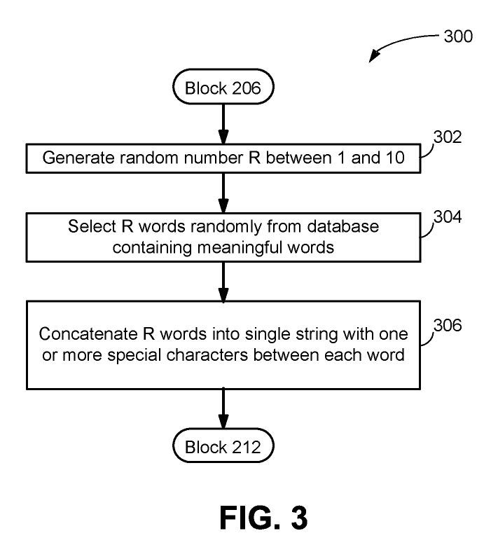

In response to not receiving a probe response including the random SSID (i.e., determination block 206=“No”), the processor may generate a second SSID including a plurality of random words in block 210. The purpose of generating such a word-based SSID is to determine whether there is a rogue AP that is configured to recognize and not respond to probe request including completely random SSIDs. In some embodiments, the second SSID may be generated in accordance with the method 300 of FIG. 3 as described below. In some embodiments, the processor may confirm that the second SSID differs from all SSIDs of legitimate APs, such as by monitoring for advertising broadcast from APs to identify their SSIDs, and then ensuring that a generated second SSID does not match any of the identified legitimate SSIDs.

In some embodiments, the processor may generate the second SSID by using a database of three-letter words. In other embodiments, the processor may generate the second SSID by using a database that contains a different number of letters and/or differing numbers of letters. In some embodiments, the processor may generate the second SSID by concatenating the plurality of random words drawn from the database into a single string. In some embodiments, the processor may use a separator placed between each of the plurality of words within the string (e.g., “dog_new_run”) to form the concatenated string. In some embodiments, the separator may be an underscore “_”. In other embodiments, the separator may be some other non-alphabetic character and/or some number of non-alphabetic characters.

In block 212, the processor may cause the Wi-Fi transceiver to transmit a second probe request including the second SSID. For example, the processor(s) 122 of the computing device 102 may utilize a probe request transmittal module 110 to generate a probe request message including the second SSID and pass that message to the Wi-Fi transceiver 134 transmission.

In determination block 214, the computing device 102 may determine whether a probe response including the second SSID is received.

In response to receiving a probe response including the second SSID (i.e., determination block 214=“Yes”), the processor may identify the AP that sent the probe response as a rogue AP in block 208. Again, the processor may also take actions to protect against an attack.

In response to not receiving a probe response including the second SSID (i.e., determination block 214=“No”), the processor may determine that no rogue APs are present in block 216. In response, the processor may enable the Wi-Fi transceiver to initiate a Wi-Fi communication link with any AP responding to a probe request including a legitimate SSID.

In some embodiments, the processor may take further actions to detect a rogue AP that is configured to defeat attempts to identify rogue APs by transmitting random SSIDs. In some embodiments, the processor may transmit the second SSID a number of times at random intervals, before determining that no rogue AP is present. An example of such a method 250 is illustrated in FIG. 2. The method 250 may be performed by a processor of a computing device, including performing the operations of blocks 202-216 of the method 200 as described above.

In response to not receiving a probe response including the second SSID (i.e., determination block 214=“No”), the processor may determine whether the operations of transmitting the second SSID and determining whether a response is received (operations 210-214) have been repeated a predetermined number of times (e.g., 5 to 10 times). In response to determining that the operations 210-214 have been performed less than the predetermined number of times (i.e., determination block 252=“No”), the processor may wait a random amount of time in block 254 before repeating those operations. In some embodiments, the processor may re-transmit the same second SSID in block 212. In other embodiments, the processor may generate another second SSID including a different plurality of random words, before transmitting another probe request in block 212.

In response to determining that the operations 210-214 has been performed the predetermined number of times (i.e., determination block 252=“Yes”), the processor may determine that no rogue APs are present in block 216. In response, the processor may enable the Wi-Fi transceiver to initiate a Wi-Fi communication link with any AP responding to a probe request including a legitimate SSID.

FIG. 3 illustrates a method 300 for randomly generating a service set identifier in accordance with various embodiments. The operations of the method 300 presented below are intended to be illustrative. In some embodiments, method 300 may be accomplished with one or more additional operations not described, and/or without one or more of the operations discussed. Additionally, the order in which the operations of the method 300 are illustrated in FIG. 3 and described below is not intended to be limiting.

In some embodiments, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of the method 300 in response to instructions stored electronically on an electronic storage medium. The one or more processing devices may include one or more devices configured through hardware, firmware, and/or software to be specifically designed for execution of one or more of the operations of the method 300. The method 300 may be performed by a processor to generate the second SSID in block 210 following the determination made in determination block 206 of the methods 200 and 250 as described above.

In block 302, the processor may generate a random number R. In various embodiments, the random number R may be between 1 and 10.

In block 304, the processor may randomly select R words from a database of words. For example, the processor may randomly generate a number R and select R words randomly from a database. In various embodiments, the database may contain a collection of meaningful words. In some embodiments, each word may have a meaning in the English language. In other embodiments, each word may have a meaning in a language other than English. In some embodiments, each word may be an English noun. In some embodiments, each word may have the same length. For example, each word may contain three letters. In other embodiments, the words contained in the database may be of various lengths.

In block 306, the processor may concatenate the R words into a single string. In various embodiments, the processor may separate each word in the single string by one or more special non-alphabetic characters. In some embodiments, the processor may use the same special non-alphabetic character. In some embodiments, the processor may use different special non-alphabetic characters. In various embodiments, the single string may be less than or equal to 32 bytes. In various embodiments, the single string may be used as the second SSID in block 212 of the methods 200 and 250 as described above.

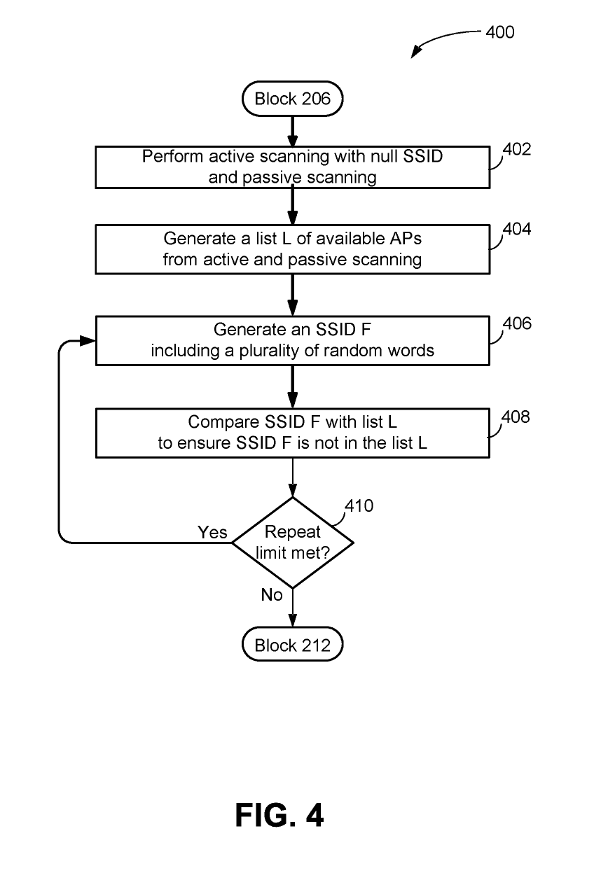

FIG. 4 illustrates a method 400 for detecting a summoning attack by a rogue AP in accordance with various embodiments. The operations of the method 400 presented below are intended to be illustrative. In some embodiments, method 400 may be accomplished with one or more additional operations not described, and/or without one or more of the operations discussed. Additionally, the order in which the operations of the method 400 are illustrated in FIG. 4 and described below is not intended to be limiting.

In some embodiments, method 400 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of the method 400 in response to instructions stored electronically on an electronic storage medium. The one or more processing devices may include one or more devices configured through hardware, firmware, and/or software to be specifically designed for execution of one or more of the operations of the method 400. The method 400 may be performed by a processor to generate the second SSID in block 210 following the determination made in determination block 206 of the methods 200 and 250 as described above.

In block 402, the processor may actively scan with a null SSID and passively scan WiFi networks to identify available APs and their SSIDs. In block 404, the processor may generate a list L of SSIDs of available APs based on the active and passive scanning

In block 406, the processor may generate a second SSID F including a plurality of random words. In some embodiments, the processor may generate the SSID F in accordance with method 300 as described with reference to FIG. 3.

In block 408, the processor may compare the generated second SSID F to the SSIDs in the list L of legitimate APs to ensure the generated second SSID F is not contained in the list L.

In determination block 410, the processor may determine whether the generated second SSID F matches any SSIDs in the list L of legitimate APs. In response to determining that the generated second SSID F matches an SSID in the list L of legitimate APs (i.e., determination block 410=“Yes”), the processor may repeat the operations in blocks 406 and 408 to ensure that the generated second SSID F is not contained in the list L.

In response to determining that the generated second SSID F does not match an SSID in the list L of legitimate APs (i.e., determination block 410=“No”), the processor may use the generated second SSID F in block 212 of the methods 200 and 250 as described above.

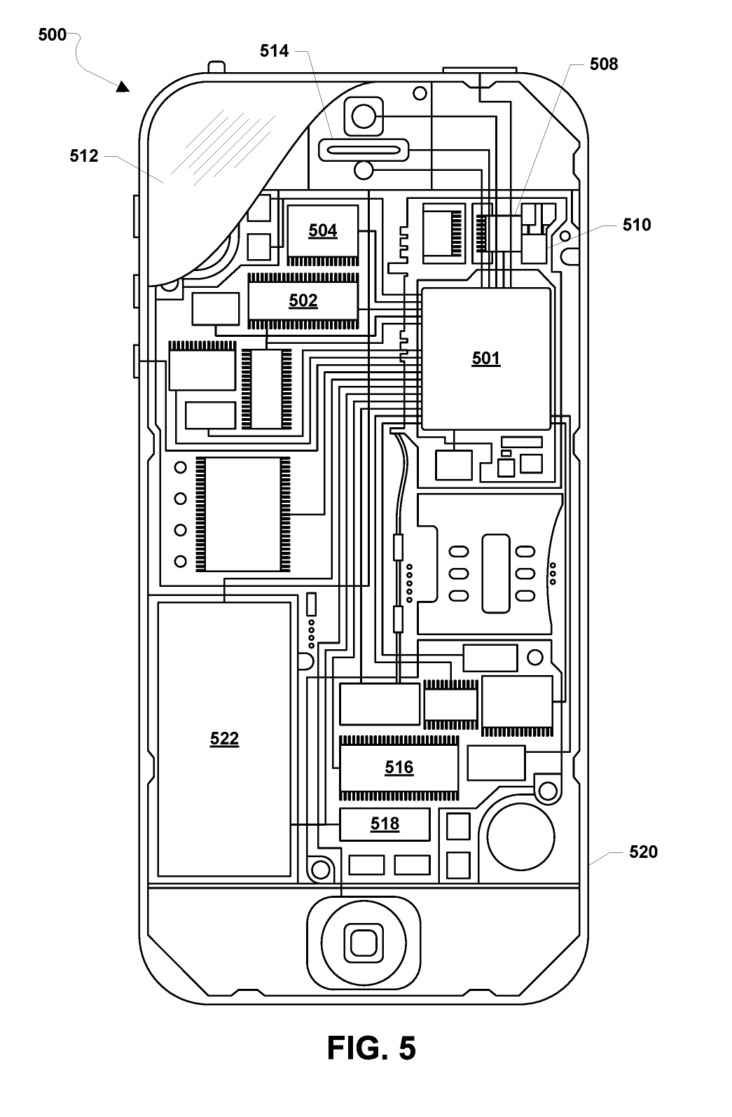

The various embodiments (including, but not limited to, embodiments discussed above with reference to FIGS. 2A-4) may be implemented in any of a variety of computing devices (i.e., receiver devices), an example of which is illustrated in FIG. 5. For example, the computing device 500 may include a processor 501 coupled to a touch screen controller 504 and an internal memory 502. The processor 501 may be one or more multicore integrated circuits (ICs) designated for general or specific processing tasks. The internal memory 502 may be volatile or non-volatile memory, and may also be secure and/or encrypted memory, or unsecure and/or unencrypted memory, or any combination thereof. The touch screen controller 504 and the processor 501 may also be coupled to a touch screen panel 512, such as a resistive-sensing touch screen, capacitive-sensing touch screen, infrared sensing touch screen, etc.

The mobile computing device 500 may have one or more radio signal transceivers 508 (e.g., Peanut®, Bluetooth®, Zigbee®, Wi-Fi, RF, cellular, etc.) and antennae 510, for sending and receiving, coupled to each other and/or to the processor 501. The transceivers 508 and antennae 510 may be used with the above-mentioned circuitry to implement the various wireless transmission protocol stacks and interfaces. The mobile computing device 500 may include a cellular network wireless modem chip 516 that enables communication via a cellular network and is coupled to the processor.

The mobile computing device 500 may include a peripheral device connection interface 518 coupled to the processor 501. The peripheral device connection interface 518 may be singularly configured to accept one type of connection, or multiply configured to accept various types of physical and communication connections, common or proprietary, such as USB, FireWire, Thunderbolt, or PCIe. The peripheral device connection interface 518 may also be coupled to a similarly configured peripheral device connection port (not shown).

The mobile computing device 500 may also include speakers 514 for providing audio outputs. The mobile computing device 500 may also include a housing 520, constructed of a plastic, metal, or a combination of materials, for containing all or some of the components discussed herein. The mobile computing device 500 may include a power source 522 coupled to the processor 501, such as a disposable or rechargeable battery. The rechargeable battery may also be coupled to the peripheral device connection port to receive a charging current from a source external to the mobile computing device 500.

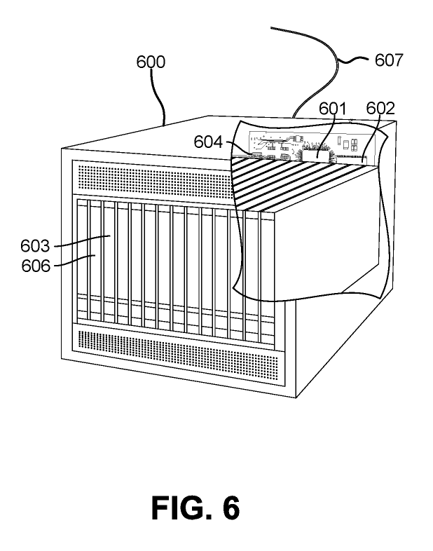

The various embodiments (including, but not limited to, embodiments discussed above with reference to FIGS. 1-4) may also be implemented on any of a variety of commercially available server devices, such as the server 600 illustrated in FIG. 6. Such a server 600 typically includes a processor 601 coupled to volatile memory 602 and a large capacity nonvolatile memory, such as a disk drive 604. The server 600 may also include a floppy disc drive, compact disc (CD) or DVD disc drive 606 coupled to the processor 601. The server 600 may also include one or more network transceivers 603, such as a network access port, coupled to the processor 601 for establishing network interface connections with a communication network 607, such as a local area network coupled to other announcement system computers and servers, the Internet, the public switched telephone network, and/or a cellular network (e.g., CDMA, TDMA, GSM, PCS, 3G, 4G, LTE, or any other type of cellular network).

The processors 501 and 601 may be any programmable microprocessor, microcomputer or multiple processor chip or chips that can be configured by software instructions (applications) to perform a variety of functions, including the functions of the various embodiments described above. In some devices, multiple processors may be provided, such as one processor dedicated to wireless communication functions and one processor dedicated to running other applications. Typically, software applications may be stored in the internal memory before they are accessed and loaded into the processors 501 and 601. The processors 501 and 601 may include internal memory sufficient to store the application software instructions. In many devices, the internal memory may be a volatile or nonvolatile memory, such as flash memory, or a mixture of both. For the purposes of this description, a general reference to memory refers to memory accessible by the processors 501 and 601 including internal memory or removable memory plugged into the device and memory within the processors 501 and 601 themselves.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

Various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described generally in terms of functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present claims.

The hardware used to implement the various illustrative logics, logical blocks, modules, and circuits described in connection with the various embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary embodiments, the functions described may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in processor-executable software, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include random access memory (RAM), read only memory (ROM), electrically erasable programmable ROM (EEPROM), FLASH memory, compact disc ROM (CD-ROM) or other optical disk storage, magnetic disk storage or other magnetic storage smart objects, or any other medium that may be used to store desired program code in the form of instructions or data structures and that may be accessed by a computer. Disk and disc, as used herein, includes CD, laser disc, optical disc, digital versatile disc (DVD), floppy disk, and Blu-ray disc where disks usually reproduce data magnetically, while discs reproduce data optically with lasers. Combinations of memory described herein are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to some embodiments without departing from the scope of the claims. Thus, the claims are not intended to be limited to the embodiments shown herein but are to be accorded the widest scope consistent with the language of the claims and the principles and novel features disclosed herein.

What is claimed is:

1. A method of operating a computing device, the method comprising:
generating, by a processor of the computing device, a random service set identifier (SSID);
transmitting, by the computing device, a WiFi probe request including the random SSID;
determining, by the processor, whether a probe response including the random SSID is received from a WiFi access point by the computing device;
identifying, by the processor, the WiFi access point as a rogue access point in response to receiving a probe response including the random SSID by the computing device; and
in response to determining that no probe response including the random SSID is received by the computing device:
generating, by the processor, a second SSID comprising a random selection of a plurality of words, the second SSID being different from an existing SSID associated with an authorized access point;
transmitting, by the computing device, a second probe request including the second SSID;
determining, by the processor, whether a probe response including the second SSID is received from a WiFi access point by the computing device;
identifying, by the processor, the WiFi access point as a malicious access point in response to determining that a probe response including the second SSID is received by the computing device from a WiFi access point; and
determining, by the processor, that no malicious WiFi access point is present in response to determining that a probe response including the second SSID is not received by the computing device from a WiFi access point.

2. The method of claim 1, wherein generating a second SSID comprising a random selection of a plurality of words comprises:
randomly selecting each of the plurality of words from a database of words; and
concatenating the plurality of words into a single string, wherein the single string is less than or equal to 32 bytes.

3. The method of claim 2, wherein concatenating the plurality of words into a single string comprises including a non-alphabetic character as a separator between each of the plurality of words.

4. The method of claim 3, wherein the non-alphabetic character is the same for each separator.

5. The method of claim 2, wherein concatenating the plurality of words into a single string comprises including one or more non-alphabetic characters as a separator between each of the plurality of words.

6. The method of claim 2, wherein concatenating the plurality of words into a single string comprises including an underscore character as a separator between each of the plurality of words.

7. The method of claim 2, wherein:
each of the plurality of words is a three-letter word;
a total number of the plurality of words is less than or equal to eight; and
a non-alphabetic character is included as a separator between each of the plurality of words.

8. The method of claim 1, wherein:
each of the plurality of words has the same number of letters; and
a total number of the plurality of words is such that a length of the second SSID is less than or equal to 32 bytes.

9. The method of claim 1, wherein:
one or more of the plurality of words has a different number of letters; and
a total number of the plurality of words is such that a length of the second SSID is less than or equal to 32 bytes.

10. The method of claim 1, further comprising:
repeatedly transmitting the second probe request including the second SSID a predetermined number of times with a random interval between each transmission; and
repeatedly determining whether a probe response including the second SSID is received.

11. A computing device comprising:
a WiFi transceiver;
a memory; and
a processor coupled to the WiFi transceiver and the memory and configured with processor-executable instructions to perform operations comprising:
generating a random service set identifier (SSID);
transmitting via the WiFi transceiver a WiFi probe request including the random SSID;
determining whether a probe response including the random SSID is received from a WiFi access point by the WiFi transceiver;
identifying the WiFi access point as a rogue access point in response to receiving a probe response including the random SSID by the WiFi transceiver; and
in response to determining that no probe response including the random SSID is received by the WiFi transceiver:
generating a second SSID comprising a random selection of a plurality of words, the second SSID being different from an existing SSID associated with an authorized access point;
transmitting via the WiFi transceiver a second probe request including the second SSID;
determining whether a probe response including the second SSID is received from a WiFi access point by the WiFi transceiver;
identifying the WiFi access point as a malicious access point in response to determining that a probe response including the second SSID is received by the WiFi transceiver from a WiFi access point; and
determining that no malicious WiFi access point is present in response to determining that a probe response including the second SSID is not received by the WiFi transceiver from a WiFi access point.

12. The computing device of claim 11, wherein the processor is configured with processor-executable instructions to perform operations such that generating a second SSID comprising a random selection of a plurality of words comprises:
randomly selecting each of the plurality of words from a database of words stored in the memory; and
concatenating the plurality of words into a single string, wherein the single string is less than or equal to 32 bytes.

13. The computing device of claim 12, wherein the processor is configured with processor-executable instructions to perform operations such that concatenating the plurality of words into a single string comprises including a non-alphabetic character as a separator between each of the plurality of words.

14. The computing device of claim 13, wherein the processor is configured with processor-executable instructions to perform operations such that the non-alphabetic character is the same for each separator.

15. The computing device of claim 12, wherein the processor is configured with processor-executable instructions to perform operations such that concatenating the plurality of words into a single string comprises including one or more non-alphabetic characters as a separator between each of the plurality of words.

16. The computing device of claim 12, wherein the processor is configured with processor-executable instructions to perform operations such that concatenating the plurality of words into a single string comprises including an underscore character as a separator between each of the plurality of words.

17. The computing device of claim 12, wherein the processor is configured with processor-executable instructions to perform operations such that:
each of the plurality of words is a three-letter word;
a total number of the plurality of words is less than or equal to eight; and
a non-alphabetic character is included as a separator between each of the plurality of words.

18. The computing device of claim 11, wherein the processor is configured with processor-executable instructions to perform operations such that:
each of the plurality of words has the same number of letters; and
a total number of the plurality of words is such that a length of the second SSID is less than or equal to 32 bytes.

19. The computing device of claim 11, wherein the processor is configured with processor-executable instructions to perform operations such that:
one or more of the plurality of words has a different number of letters; and
a total number of the plurality of words is such that a length of the second SSID is less than or equal to 32 bytes.

20. The computing device of claim 11, wherein the processor is configured with processor-executable instructions to perform operations further comprising:
repeatedly transmitting the second probe request including the second SSID a predetermined number of times with a random interval between each transmission; and
repeatedly determining whether a probe response including the second SSID is received.

21. A non-transitory processor-readable medium having stored thereon processor-executable instructions configured to cause a processor of a computing device to perform operations comprising:
generating a random service set identifier (SSID);
transmitting via a WiFi transceiver a WiFi probe request including the random SSID;
determining whether a probe response including the random SSID is received from a WiFi access point by the WiFi transceiver;
identifying the WiFi access point as a rogue access point in response to receiving a probe response including the random SSID by the WiFi transceiver; and
in response to determining that no probe response including the random SSID is received by the WiFi transceiver:
generating a second SSID comprising a random selection of a plurality of words, the second SSID being different from an existing SSID associated with an authorized access point;
transmitting via the WiFi transceiver a second probe request including the second SSID;
determining whether a probe response including the second SSID is received from a WiFi access point by the WiFi transceiver;
identifying the WiFi access point as a malicious access point in response to determining that a probe response including the second SSID is received by the WiFi transceiver from a WiFi access point; and
determining that no malicious WiFi access point is present in response to determining that a probe response including the second SSID is not received by the WiFi transceiver from a WiFi access point.

22. The non-transitory processor-readable medium of claim 21, wherein the processor is configured with processor-executable instructions to perform operations such that generating a second SSID comprising a random selection of a plurality of words comprises:
randomly selecting each of the plurality of words from a database of words; and
concatenating the plurality of words into a single string, wherein the single string is less than or equal to 32 bytes.

23. The non-transitory processor-readable medium of claim 22, wherein the processor is configured with processor-executable instructions to perform operations such that concatenating the plurality of words into a single string comprises including a non-alphabetic character as a separator between each of the plurality of words.

24. The non-transitory processor-readable medium of claim 22, wherein the processor is configured with processor-executable instructions to perform operations such that concatenating the plurality of words into a single string comprises including one or more non-alphabetic characters as a separator between each of the plurality of words.

25. The non-transitory processor-readable medium of claim 22, wherein the processor is configured with processor-executable instructions to perform operations such that concatenating the plurality of words into a single string comprises including an underscore character as a separator between each of the plurality of words.

26. The non-transitory processor-readable medium of claim 22, wherein the processor is configured with processor-executable instructions to perform operations such that:
each of the plurality of words is a three-letter word;
a total number of the plurality of words is less than or equal to eight; and
a non-alphabetic character is included as a separator between each of the plurality of words.

27. The non-transitory processor-readable medium of claim 21, wherein the processor is configured with processor-executable instructions to perform operations such that:
each of the plurality of words has the same number of letters; and
a total number of the plurality of words is such that a length of the second SSID is less than or equal to 32 bytes.

28. The non-transitory processor-readable medium of claim 21, wherein the processor is configured with processor-executable instructions to perform operations such that:
one or more of the plurality of words has a different number of letters; and
a total number of the plurality of words is such that a length of the second SSID is less than or equal to 32 bytes.

29. The non-transitory processor-readable medium of claim 21, wherein the processor is configured with processor-executable instructions to perform operations further comprising:
repeatedly transmitting the second probe request including the second SSID a predetermined number of times with a random interval between each transmission; and
repeatedly determining whether a probe response including the second SSID is received.

30. A computing device comprising:
means for generating a random service set identifier (SSID);
means for transmitting via the WiFi transceiver a WiFi probe request including the random SSID;
means for determining whether a probe response including the random SSID is received from a WiFi access point by the WiFi transceiver;
means for identifying the WiFi access point as a rogue access point in response to receiving a probe response including the random SSID by the WiFi transceiver; and
means for generating a second SSID comprising a random selection of a plurality of words, the second SSID being different from an existing SSID associated with an authorized access point in response to determining that no probe response including the random SSID is received by the WiFi transceiver;
means for transmitting via the WiFi transceiver a second probe request including the second SSID;
means for determining whether a probe response including the second SSID is received from a WiFi access point by the WiFi transceiver;
means for identifying the WiFi access point as a malicious access point in response to determining that a probe response including the second SSID is received by the WiFi transceiver from a WiFi access point; and
means for determining that no malicious WiFi access point is present in response to determining that a probe response including the second SSID is not received by the WiFi transceiver from a WiFi access point.
